(19) United States
(12) Patent Application Publication
(10) Pub. No.: US 2009/0106096 A1
(43) Pub. Date: Apr. 23, 2009

(54) Online Advertisement Delivery Based on User Feedback

(76) Inventor: Steven Horowitz, Oakland, CA (US)

Correspondence Address: STATTLER - SUH PC, 60 SOUTH MARKET STREET, SUITE 480, SAN JOSE, CA, 95113, US

(21) Appl. No.: 11/876,384

(22) Filed: Oct. 22, 2007

(51) Int. Cl. G06Q 30/00

(52) U.S. Cl. 705/14

(57) ABSTRACT

A method and system are provided for online ad delivery based on user feedback. In one example of the method, the method includes creating a categorized ad, serving the categorized ad and its integrated link to a user, receiving user feedback from the categorized ad to formulate a user feedback state of the ad for the user, and combining the user feedback state with existing ad serving criteria.

### FIELD OF THE INVENTION

The present invention relates to online ad delivery. More particularly, the present invention relates to online ad delivery based on user feedback.

### BACKGROUND OF THE INVENTION

Online networks, such as the Internet, connect a multitude of different users to an abundance of content. Just as the users are varied, the content is similarly varied in nature and type. In particular, the Internet provides a mechanism for merchants to offer a vast amount of products and services to consumers. Internet portals provide users an entrance and guide into the vast resources of the Internet. Typically, an Internet portal provides a range of search, email, news, shopping, chat, maps, finance, entertainment, and other Internet services and content. Yahoo!® is an example of such an Internet portal.

When a user visits certain locations on the Internet (e.g., web sites), including an Internet portal, the user enters information in the form of online activity. This information may be recorded and analyzed to determine behavioral patterns and interests of the user. In turn, these behavioral patterns and interests may be used to target the user to provide a more meaningful and rich experience on the Internet, such as an Internet portal site. For example, if interests in certain products and services of the user are determined, advertisements and other content, pertaining to those products and services, may be served to the user. A behavioral targeting system that serves highly appropriate content benefits both the content provider, who provides their message to a target audience, and a user that receives content in areas of interest to the user.

Currently, providing content through computer networks such as the Internet is widespread along with content through other mediums, such as television, radio, or print. Different online content has different objectives and appeal depending on the user toward whom the content is targeted. The value to the user of media or a particular medium will largely be based on the quality of the content provided to the user. Quality has a number of factors, including the relevance to a specific user at a specific moment in time, for instance. Hence, considering the vast amount of information available to the broad spectrum of disparate users, the delivery of quality content at any given time is not a trivial task.

### SUMMARY OF THE INVENTION

What is needed is an improved system having features for addressing the problems mentioned above and new features not yet discussed. Broadly speaking, the present invention fills these needs by providing a method and system for online ad delivery based on user feedback. It should be appreciated that the present invention can be implemented in numerous ways, including as a method, a process, an apparatus, a system or a device. Inventive embodiments of the present invention are summarized below.

In one embodiment, a method of online ad delivery based on user feedback is provided. The method comprises creating a categorized ad, serving the categorized ad and its integrated link to a user, receiving user feedback from the categorized ad to formulate a user feedback state of the ad for the user, and combining the user feedback state with existing ad serving criteria.

In another embodiment, an apparatus for online ad delivery based on user feedback is provided. The apparatus comprises a creating device configured to create a categorized ad, a serving device configured to serve the categorized ad and its integrated link to a user, a receiver device configured to receive user feedback from the categorized ad to formulate a user feedback state of the ad for the user, and a combining device configured to combine the user feedback state with existing ad serving criteria.

In still another embodiment, a computer-readable medium carrying one or more instructions for online ad delivery is provided. The one or more instructions, when executed by one or more processors, cause the one or more processors to perform the steps of creating a categorized ad, serving the categorized ad and its integrated link to a user, receiving user feedback from the categorized ad to formulate a user feedback state of the ad for the user, and combining the user feedback state with existing ad serving criteria.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a webpage that includes typical display ads and a categorized ad, in accordance with an embodiment of the present invention;

FIG. 2 is a flowchart of a method of online advertisement based on user feedback from a categorized ad, in accordance with an embodiment of the present invention;

FIG. 3A is an example of a categorized ad that has an integrated link showing a “more” option, in accordance with an embodiment of the present invention;

FIG. 3B is an example of a categorized ad that has an integrated link showing a “fewer” option, in accordance with an embodiment of the present invention;

FIG. 4 is an example of a categorized ad that has an integrated link showing both a “more” option and an “fewer” option, in accordance with an embodiment of the present invention;

FIG. 5A is an example of a categorized ad that has an integrated link showing different gradient levels that a user may select, in accordance with an embodiment of the present invention;

FIG. 5B is the categorized ad of FIG. 5A after the user has selected a gradient level indicating a preference for receiving the categorized ad, in accordance with an embodiment of the present invention;

FIG. 5C is the categorized ad of FIG. 5A after the user has selected a gradient level indicating a strong preference for receiving the categorized ad, in accordance with an embodiment of the present invention;

FIG. 5D is the categorized ad of FIG. 5A after the user has selected a gradient level indicating a preference for not receiving the categorized ad, in accordance with an embodiment of the present invention;

FIG. 5E is the categorized ad of FIG. 5A after the user has selected a gradient level indicating a strong preference for not receiving the categorized ad, in accordance with an embodiment of the present invention;

FIG. 6 is a high-level block diagram of an ad system, in accordance with an embodiment of the present invention; and

FIG. 7 is a basic flowchart of a method of online advertisement based on feedback from a categorized ad, in accordance with an embodiment of the present invention.

### DETAILED DESCRIPTION

An invention for a method and system of online advertisement delivery based on user feedback is disclosed. Numerous specific details are set forth in order to provide a thorough understanding of the present invention. It will be understood, however, to one skilled in the art, that the present invention may be practiced with other specific details.

Display ads on the Internet are a type of advertising that contains graphic information beyond text. Such graphic information may include logos, photograph or other pictures, location maps and other similar items. Users are typically able to click on these categorized ads to learn more information about the advertiser's offer or directly call the advertiser. Yahoo!® is an example of a company that provides comprehensive solutions across both graphical and search advertising, including customized research and unparalleled targeting and measurement capabilities, for major marketers and agencies. Yahoo!® works with a large majority of top advertisers to provide brand advertising services. Yahoo!® also works with less sophisticated advertisers to meet their needs as well.

The placement of advertisements on the Internet is naturally dependent on how much money the particular client pays for their advertising campaign. For the purposes of this invention, the cost of an advertisement is a function of the ad's impressions. An impression is the count of a delivered basic advertising unit from an ad distribution point. For example, an impression is counted every time an ad is rendered in the user's browser. Impressions are how most Internet advertising is sold. The cost is quoted in terms of cost per thousand impressions (CPM). Advertisers running CPM ads set their desired price per thousand ads served may select the specific sites on which to show their ads, and pay each time their ad appears. For publishers, such as Yahoo!®, this system means revenue in the publisher's account each time a CPM ad is served to a browsed webpage. CPM ads compete against pay-per-click (or CPC, cost per click) ads in ad auctions. Accordingly, only the highest performing ads will be served to highly trafficked webpages. An advertisement, placed on a high level webpage will typically have a higher CPM than the same advertisement placed on a relatively lower level webpage. An example of a high level webpage is http://finance.Yahoo.com. An example of a relatively lower level webpage is http://finance.Yahoo.com/marketupdate/overview. There are many factors that determine the CPM of a particular advertisement. Generally, a higher level webpage commands a higher CPM for an ad to be placed on that webpage. CPM ads include, but are not limited to, text, image, animation, interactive, audio and video ads.

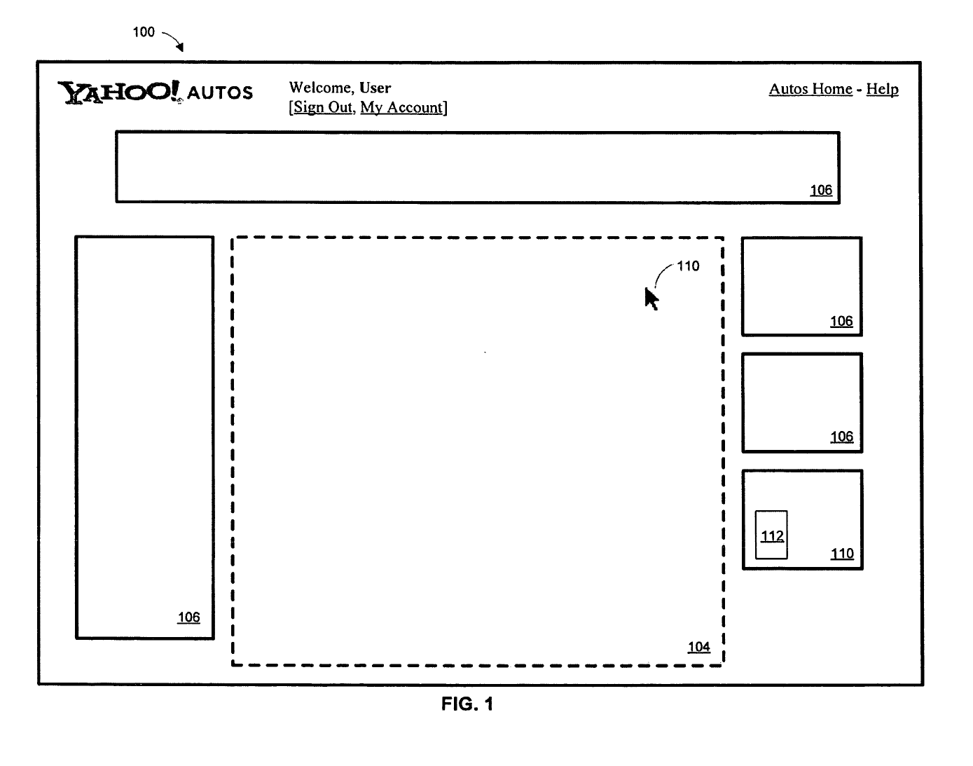

FIG. 1 is a webpage 100 that includes typical display ads 106 and a categorized ad 110, in accordance with an embodiment of the present invention. This webpage 100 is directed toward Yahoo!® Autos. A user named “User” is currently signed on. For explanatory purposes, the content 104 is located near the middle of the webpage 100. Content is generally the subject matter of a particular webpage. For example, an online article is content.

Display ads 106 may appear anywhere on the webpage 100, be any size and shape, and be any media format. For example, a display ad 106 may be an LREC (“large rectangle”) having dimensions of 300 pixels by 250 pixels. However, the embodiment is not so limited. There are many sizes, shapes and media formats available for display ads 106 that may include, but are not limited to, text, image, animation, interactive, audio and video.

The categorized ad 110 of this embodiment is configured to obtain specific feedback from the user. The categorized ad 110 is basically a display ad that includes an integrated link 112 for providing additional functionality to the categorized ad 110. The integrated link 112 may be any size, shape and interactive media format, and appear anywhere in or near the categorized ad 112. For example, the integrated link 112 may be a small overlay rectangle containing a clickable graphic. However, the embodiment is not so limited. The integrated link 112 may appear above, below or alongside the categorized ad 110, or appear only when the user moves the browser cursor over or near the categorized ad 110. There are many sizes, shapes and media formats available for integrated link 112 that may include, but are not limited to, text, image, animation, and interactive. It is important to note that this categorized ad 110 with the additional functionality is the essence of the present invention.

A publisher, such as Yahoo!®, is faced with the challenge of providing effective advertising services for their ad clients while keeping the ad experience minimally intrusive to users. In other words, an ad should not be too annoying to the user as to render the ad ineffective; however, the ad must maintain a minimum Internet presence for which the ad client has paid.

A publisher, such as Yahoo!®, delivers display advertisements on a web page via several methods, including run of network, sponsoring, demographic targeting, geographic targeting, content matching and behavioral targeting. Run of network involves no targeting; the ad is potentially placed anywhere on the network to which the portal accesses. Sponsoring involves the advertiser buying space on particular webpages.

Demographic targeting is ad targeting based on explicit user demographic information. The portal may obtain, among other things, gender and age information during user sign-up. Accordingly, for demographic targeting to be effective, the user must be signed-in to the particular portal during browsing.

Geographic targeting is based on explicit location information of the user. The portal may obtain the user's zip code at sign-up. The portal may also obtain the user computer's internet protocol (IP) address using reverse IP look up. Furthermore, the portal may also obtain the user's current location, for example via GPS.

Content matching is an ad targeting technique based on content 104 on the webpage. An example of content matching is the technology utilized by Yahoo!®. This technology involves extracting major subject matter key words from the content 104 on a particular webpage the user is browsing. The proper ad is then associated with the content on the currently browsed webpage. To achieve such matching, each ad contains metadata (e.g., tags). The metadata also specifies categories from the larger taxonomy (i.e., categorization) of all ads. For example, an ad for the Apple iPod®, may be categorized in “music”. Accordingly, the metadata for an ad for the Apple iPod® would indicate the ad is categorized within music, and may have associated tags “artist,” album,” “song,” etc. The taxonomy does not have to be perfect or rigid. For example, the Apple iPod® may be categorized in “electronics” as well as “music,” with the subcategory “digital music player.” An advantage of content matching is that this technique does not require the user to be signed-in, as the ad is being matched to content on the browsed webpage, as opposed to traits of the user. A downfall of this metadata method is that sometimes the wrong ad is rendered because the content matching yields unacceptable numbers of false matches.

Behavioral targeting is an ad targeting technique based on history of pages visited by the user. This technique starts by obtaining basic information through user sign-up. As discussed above, certain demographic information that the portal may obtain through sign-up typically includes zip code, gender and age. Then, the portal tracks sites visited by the user to infer information about the user. An advantage of this technique is that it can provide ads that are directed to the traits of the user. An obstacle of this technique is trying to determine if the user is “in market”, for example, looking to buy a new car. Advertisers are generally not interested in advertising to users who are not in market, for example, just browsing new cars after having just bought one.

There are at least three ways to track and store behavioral information. A first way is to track the browsing activities of registered users via a user-indexed database. At sign-up to a portal, such as Yahoo!®, the portal assigns the user a unique user identifier in a registered user database of the portal. Whenever the user is signed-in and browsing, the portal can track the browsing history of the user by saving this information directly into the user database. This tracking technique is preferable because it is persistent over time, and allows analysis of, and decisions based on aggregated user behaviors, such as with collaborative filtering.

Collaborative filtering is the method of making automatic predictions (filtering) about the interests of a single user by collecting preference information from many users (collaborating). The underlying assumption of the collaborative filtering approach is that those who agreed in the past tend to agree again in the future. For example, a collaborative filtering or recommendation system for music preferences could make predictions about which music a user should like given a partial list of that user's preferences (likes or dislikes). Note that these predictions are specific to the user, but use information collected from many users. Collaborative filtering differs from the more simple approach of giving an average (non-specific) score for each item of interest, for example based on its number of votes. Yahoo!® Launchcast is an example of a service that utilizes collaborative filtering.

A second way is to track the browsing activities of registered users via persistent cookies. Cookies are parcels of text sent by a server to a web browser and then sent back unchanged by the browser each time it accesses that server. Cookies are used for authenticating, tracking, and maintaining specific information about users, such as site preferences and the contents of their electronic shopping carts. At sign-up to a portal, such as Yahoo!®, the portal assigns the user a unique user identifier in a user database of the portal. Whenever the user is signed-in and browsing, the portal can track the browsing history of the user using persistent cookies. This tracking technique of using persistent cookies is also preferable because it is persistent over time.

A third way to track behavioral information is through session cookies. For example, during a browsing session, the portal may receive zip information from an unregistered or a signed-out user. In such a case, that zip code would be stored in a session cookie. A problem with session cookies is that the portal may lose behavioral tracking information over time. The user may clear the session cookies from memory; and session cookies are first in/first out. Another problem with session cookies is that for an unregistered or signed-out user using multiple computers, the portal will falsely recognize one user as being multiple different users. Still another problem with session cookies is that the particular browser, computer or local area network may be blocking cookies altogether.

The targeting methods described above represent different “best guesses” as to what the user is “in market” to purchase. These best guesses are based on inferences derived from who the user is, where the user is and what the user is or was viewing. Generally, these ad targeting techniques allow publishers to display ads in an efficient manner by displaying ads intelligently to a user or a browsed webpage matching certain criteria. However, there is still some improvement of these ad targeting techniques that are left to be desired. An improvement proposed by the present invention is a method that solicits explicit feedback from the user while viewing a categorized ad.

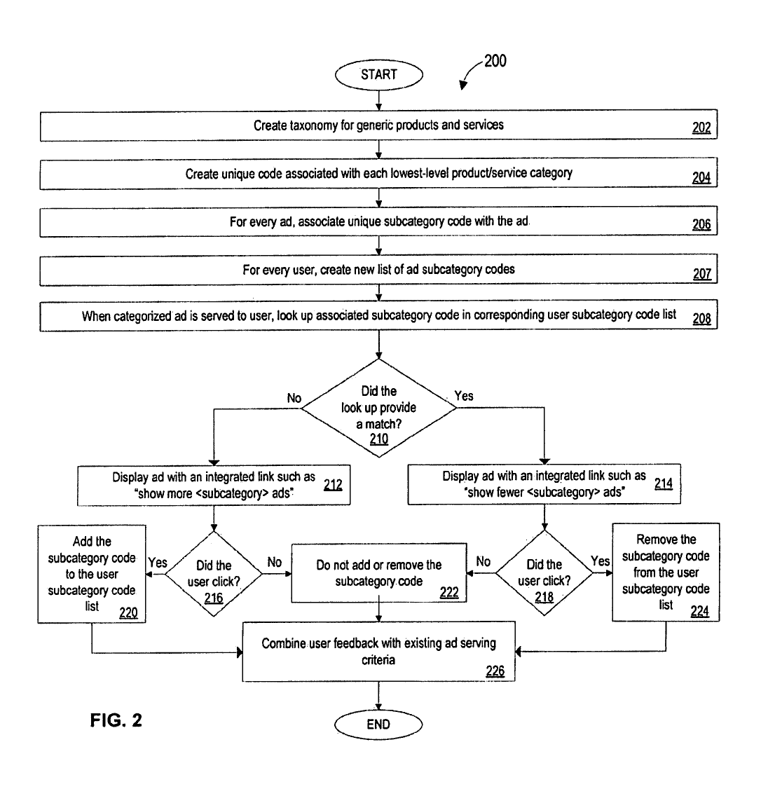

FIG. 2 is a flowchart of a method 200 of online advertisement based on user feedback from a categorized ad, in accordance with an embodiment of the present invention. The ad system creates categorized ads. Accordingly, the method 200 starts in step 202 where the ad system (i.e., publisher) creates a comprehensive taxonomy for generic products and services (no brands). Examples of these products and services may be found on shopping sites, such as Yahoo!® Shopping, Amazon®, and eBay®. An example of a multi-level taxonomy is “Products”, with a category “Autos,” which has subcategories of “sedans”, “SUV's”, “trucks, “vans”, etc. Another example of a multi-level taxonomy would be “Services” with a category “Finance,” which has subcategories of “banking”, “brokerage”, “mortgage”, “financial planning”, etc.

The method 200 then moves to step 204, where the ad system creates unique codes associated with each lowest-level product/service subcategory. For every ad entered into ad inventory that can be categorized uniquely, in step 206, the ad system associates a particular unique code with the ad. In other words, this unique categorization involves inserting information into each ad's metadata, numeric identifications, tags, keywords or similar. The method then moves to step 207. For every registered user, in step 207, the ad system creates a new ad subcategory code list in the registered user database indexed by user identifier. Alternatively, for every signed-in user, the ad system creates a new persistent cookie with a list of subcategory codes. Alternatively, for every unregistered user or signed-out user, the ad system creates a new session cookie with a list of ad subcategory codes. This last alternative may be less desirable because the ad system would have to use session cookies, which have drawbacks as discussed with reference to FIG. 1.

When a categorized ad is served to a user, in step 208, the ad system looks up the associated subcategory code of the categorized ad in the corresponding user ad subcategory code list. Then, in decision operation 210, the ad system determines whether the look up provided a positive match. A positive match means that the ad system has information which indicates the categorized ad is preferable to the user if there is no positive match, the method 200 proceeds to step 212. Here, the ad system displays the ad with an integrated link such as “show more <subcategory> ads”, where “<subcategory>” is the text associated with the subcategory code associated with the ad, for example “show more SUV ads.” Then, in decision operation 216, the ad system determines if the user clicks the link. If there is a click, the method 200 proceeds to step 220, where the ad system adds the subcategory code to the corresponding user ad subcategory code list. Alternatively, if a user clicks through a display ad, usually to the advertiser's website, the publisher may opt to add the subcategory code to the list. Clicking through a display ad implies user interest.

On the other hand, if there is a positive match in decision operation 210, the method 200 proceeds to step 214. Here, the ad system displays the categorized ad with an integrated link such as “show fewer <subcategory> ads”, where “<subcategory>” is the text associated with the subcategory code associated with the ad, for example “show fewer SUV ads.” Then, in decision operation 218, the ad system determines if the user clicks the link. If there is a click, the method 200 proceeds to step 224, where the ad system removes the subcategory code from the corresponding user ad subcategory code list. Step 224 is useful when a previously in-market user has made a purchase decision. It may be undesirable to allow step 224 on all ads regardless of a match, because doing so may convey the impression that by choosing fewer ads every time, the user might actually decrease the number of display ads served.

If the ad system determines the user has not clicked in decision operations 216 or 218, the method 200 proceeds to step 222. Here, the ad system neither adds nor removes the subcategory code.

The method 200 then moves to step 226, where the ad system combines user feedback, or lack of user feedback, with existing ad serving criteria. Step 226 may incorporate collaborative filtering or machine learning to hone in on the user's ideal ad experience. However, it is important to note that, although the method 200 of the present invention may utilize collaborative filtering, the method 200 requires far less involvement from the user than a pure collaborative filtering scheme. The method 200 is then at an end.

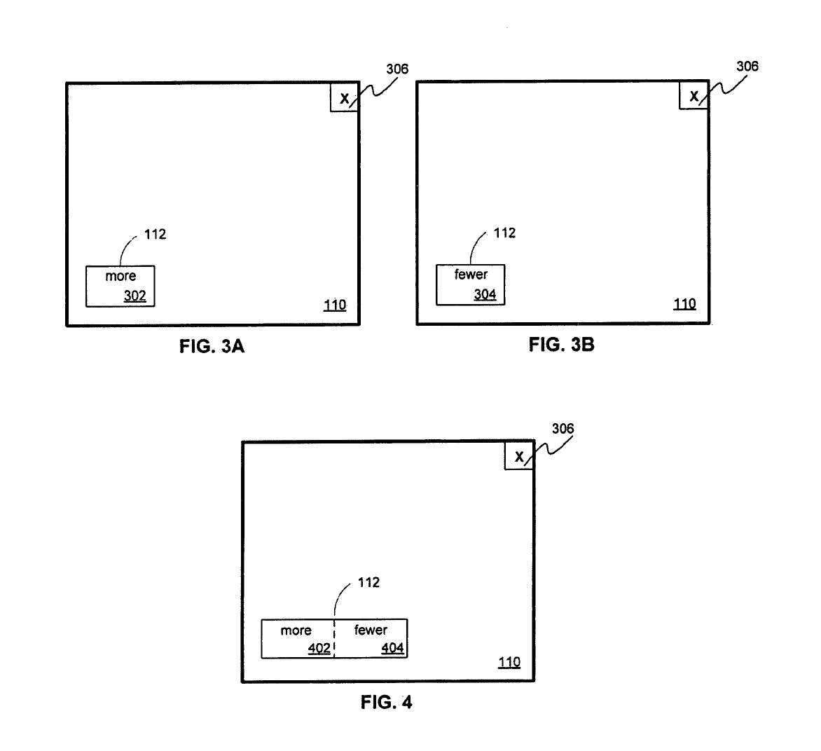

FIG. 3A is an example of a categorized ad 110 that has an integrated link 112 showing a “more” option 302, in accordance with an embodiment of the present invention. The categorized ad 110 may also include a close button 306. The integrated link 112 allows the user to provide feedback to the ad publisher, Yahoo!® for example, about this particular ad or ad type. Note that if there is no positive match in the ad system when the ad system initially serves the categorized ad 202 to the user, the initial display of the integrated link 204 is preferably the “more” option 302. In this example, the integrated link 112 initially includes the “more” option 302 before the ad system has received any user feedback from the user. At this point, the user feedback for this particular user is at a zero (0) state because the user has not yet provided user feedback. A feedback state indicates to the ad system whether or not the user would like to see more ads similar to the categorized ad.

In an alternative embodiment, the “more” option 302 may be other text or other graphics, instead of the text “more”. For example, the “more” option 302 may read “show more <subcategory> ads”, where <subcategory> is the text associated with the subcategory code of the ad. The integrated link 112, then behaves as discussed above with reference to FIG. 2.

FIG. 3B is an example of a categorized ad 110 that has an integrated link 112 showing a “fewer” option 302, in accordance with an embodiment of the present invention. In this example, the “more” option 302 of FIG. 3A is toggled to become the “fewer” option 304 of FIG. 3B after the user selected the “more” option 302 of FIG. 3A. At this point, the user feedback for this particular user is at a one (1) state because the user has provided user feedback indicating the user prefers more of this type of ad. Another way for the user feedback to move to a one (1) state is for the user to click directly on the categorized ad 110. In such a case, the ad system my send the user to the advertiser's website or display more ads similar to the selected categorized ad 110. Note that if there was a positive match in the ad system when the ad system initially served the categorized ad 110 to the user, the initial display of the integrated link 112 would preferably be a “fewer” option 304.

In an alternative embodiment, the “fewer” option 304 may be other text or other graphics, instead of the text “fewer”. For example, the “fewer” option 304 may read “show fewer <subcategory> ads”, where <subcategory> is the text associated with the subcategory code of the ad. The integrated link 112, then behaves as discussed above with reference to FIG. 2.

At this point, the user may select the “fewer” option 304. The integrated link 112 then toggles to the “more” option 302. The user feedback for this particular user is reset to the zero (0) state because the user has provided user feedback indicating the user does not prefer more of this type of ad. Another way for the user feedback to reset to the zero (0) state is for the user to close the ad using a close button 306.

FIG. 4 is an example of a categorized ad 110 that has an integrated link 112 showing both a “more” option 402 and an “fewer” option 404, in accordance with an embodiment of the present invention. The user has the option of selecting the “more” option 402 or the “fewer” option 404. This integrated link 112 provides for somewhat more user control than just the integrated link 112 of FIGS. 3A-3B.

The user feedback starts off at a zero (0) state in FIG. 4 before the user has provided any user feedback. If the user selects the “more” option 402 of FIG. 4, the ad system then displays the integrated link 112 of FIG. 3B showing only a “fewer” option, and the user feedback moves to what may be a positive one (+1) state. Another way for the user feedback to move to a positive state may be for the user to click directly on the categorized ad 110. In such a case, the ad system my send the user the advertiser's website or display more ads similar to the selected categorized ad 110.

However, if the user selects the “fewer” option 404 of FIG. 4, the ad system then displays the integrated link 112 of FIG. 3A showing only a “more” option, and the user feedback moves to what may be a negative one (−1) state. Another way for the user feedback to move to a negative state may be for the user to close the ad using a close button 306.

In this example, if the user feedback is in the positive one (+1) state and the user clicks on the “fewer” option 302 of FIG. 3B, the user feedback is reset to the zero (0) state, indicating no preference, and the ad system then displays the combined integrated link 112 of FIG. 4. Similarly, if the user feedback is in the negative one (−1) state and the user clicks on the “more” option 304 of FIG. 3A, the user feedback is also reset to the zero (0) state, indicating no preference, and the ad system then displays the combined integrated link 112 of FIG. 4.

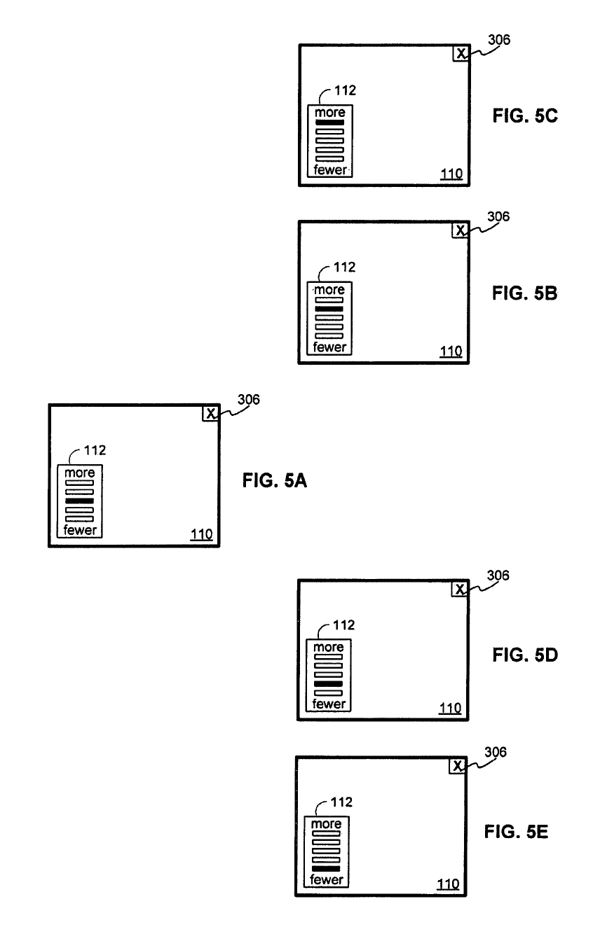

FIG. 5A is an example of a categorized ad 110 that has an integrated link 112 showing a gradient with different levels that a user may select, in accordance with an embodiment of the present invention. The gradient levels are the relative degrees to which the user desires more or fewer ads similar to the categorized ad 110. In this example, these levels may be mapped into real-valued states from negative 1 (−1) to positive 1 (+1). This example shows the integrated link 112 having five different levels. The user feedback starts off at a zero (0) state in the middle of the gradient before the user has provided any user feedback.

FIG. 5B is the categorized ad 110 of FIG. 5A after the user has selected a gradient level indicating a preference for receiving the categorized ad, in accordance with an embodiment of the present invention. Selecting a gradient level closer to “more” increases the user feedback state and provides an indication to the ad system that the user prefers receiving the ad type according to the selected gradient level.

FIG. 5C is the categorized ad 110 of FIG. 5A after the user has selected a gradient level indicating a strong preference for receiving the categorized ad, in accordance with an embodiment of the present invention. The highest state here may be positive one (+1) to indicate to the ad system that the user strongly prefers receiving the displayed ad type. Another way for the user feedback state to increase is for the user to click directly on the categorized ad 110. In such a case, the ad system may send the user the advertiser's website or may display more ads similar to the selected categorized ad 110.

FIG. 5D is the categorized ad 110 of FIG. 5A after the user has selected a gradient level indicating a preference for not receiving the categorized ad, in accordance with an embodiment of the present invention. Selecting a gradient level closer to “fewer” decreases the user feedback state and provides an indication to the ad system that the user prefers not receiving the ad type according to the selected gradient level.

FIG. 5E is the categorized ad 110 of FIG. 5A after the user has selected a gradient level indicating a strong preference for not receiving the categorized ad, in accordance with an embodiment of the present invention. The lowest state here may be negative one (−1) to indicate to the ad system that the user strongly prefers not receiving the displayed ad type. Another way for the user feedback state to decrease is for the user to close the ad using a close button 306.

The integrated link 112 of FIGS. 5A-5E shows a gradient of five levels for explanatory purposes. However, the embodiment is not so limited. The gradient may include any number of different levels. For example, the gradient may alternatively include just two different levels, or the gradient may include as many as 100 different levels. The gradient levels may map to any number of states. For example, the five levels may be mapped into five integer valued states from −2 to +2.

Other examples of a categorized ad 110 are within the scope of the present invention. For example, the categorized ad 110 may have an integrated link that has mouse-over capabilities, where the integrated link becomes bigger for the user to see as the user moves the mouse over the integrated link.

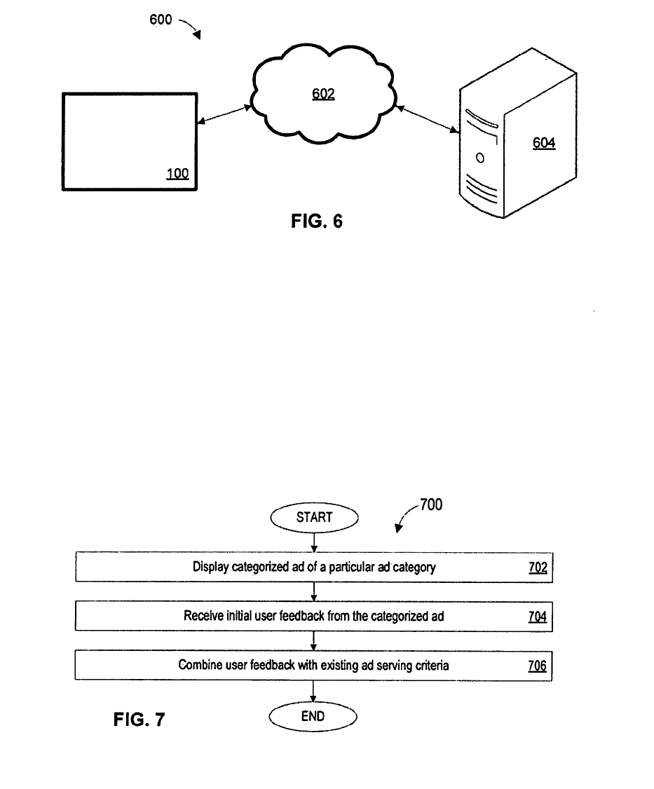

FIG. 6 is a high-level block diagram of an ad system 600, in accordance with an embodiment of the present invention. The ad system 600 includes an ad server 604, the Internet 602 and a webpage 100, among other components. The webpage 100 is coupled to an ad server 604 via the Internet 602. The Internet 602 is coupled to the webpage 100. The ad system 600 is configured to carry out a method of the present invention via one or more ad devices (not shown). An ad device is software, hardware or a combination thereof. The ad devices include a creating device, a serving device, a receiving device and a calculating device. The creating device is configured to create a categorized ad. The serving device is configured to serve the categorized ad and its integrated link to a user. The receiver device is configured to receive user feedback from the ad and its integrated link and a click on the ad. The combining device is configured to combine user feedback of the categorized ad with existing ad serving criteria. The creating device, server device, receiving device and combining device are preferably part of the ad server 604. These ad devices may also be located anywhere within the ad system 600. Alternatively, an approved third-party ad server (not shown) may be called upon to serve display ads to the webpage 600.

FIG. 7 is a basic flowchart of a method 700 of online advertisement based on feedback from a categorized ad, in accordance with an embodiment of the present invention. The method 700 starts in step 702 where the integrated link displays a categorized ad of a particular ad category. Then, in step 704, the integrated link receives initial user feedback, or no user feedback, from the categorized ad. The ad system uses this initial user feedback, or lack of feedback, to formulate a state indicating whether the user desires more or fewer ads similar to the displayed categorized ad. Next, in step 706, the ad system combines the user feedback state with existing ad serving criteria. The method 700 is then at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including but not limited to creating a categorized ad, serving the categorized ad and its integrated link to a user, receiving user feedback from the categorized ad to formulate a user feedback state of the ad for the user, and combining the user feedback state with existing ad serving criteria, according to processes of the present invention.

### ADVANTAGES OF THE PRESENT INVENTION

The present invention gives the user the opportunity (but not requirement) to explicitly indicate interest in specific products or services. This opportunity is particularly valuable to users who are “in market” for a product or service, for example, looking to buy a new car. Serving ads based on this criterion is better than inferring in-market status from demographic, or even content and behavioral statistics. For example, someone reading a Yahoo!® News article about GM®, or visiting Yahoo!®'s Pontiac® Enthusiast site, may already own a late-model Pontiac® and, thus, is not looking to buy a new one. The odds are better that a user is looking to buy an SUV if the user clicks “show more SUV ads.” Accordingly, the language used in the categorized ad 110 is important. For example, an integrated link such as “show more SUV ads” may be better than “more like this” or a thumbs up/down rating. The words “show more SUV ads” call out the product or service subcategory, thereby separating content from esthetics. For example, a user might want to see more ads featuring funny situations or scantily-clad women regardless of the product or service and, thus, might mistake “more like this” or a thumbs up/down rating as a means to achieve that result. Finally, having the user click on the integrated feedback link during the ad impression itself proves much less of a barrier than setting up and maintaining user ad profiles. A user ad profile is an explicit checklist of products and services categories in which the user indicates interest.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of online ad delivery, the method comprising:
creating a categorized ad;
serving the categorized ad and its integrated link to a user;
receiving user feedback from the categorized ad to formulate a user feedback state of the ad for the user; and
combining the user feedback state with existing ad serving criteria.

2. The method of claim 1, wherein creating the categorized ad comprises creating a taxonomy for generic products and services, wherein the taxonomy includes lowest level subcategories for products and services.

3. The method of claim 2, wherein creating the categorized ad further comprises creating a unique code for each lowest level product subcategory and for each lowest level service subcategory.

4. The method of claim 3, wherein creating the categorized ad further comprises creating an association between at least one unique code and each categorized ad.

5. The method of claim 4, wherein creating the categorized ad further comprises creating a new list of ad subcategory codes for at least one user.

6. The method of claim 5, wherein combining the user feedback state comprises looking up an associated subcategory code of the categorized ad.

7. The method of claim 1, wherein the user is a registered user.

8. The method of claim 1, wherein the user is at least one of an unregistered user and a signed-out user.

9. The method of claim 7, further comprising tracking browsing history of the user via a user database.

10. The method of claim 7, further comprising tracking browsing history of the user via persistent cookies.

11. The method of claim 8, further comprising tracking browsing history of the user via session cookies.

12. The method of claim 1, wherein the method further comprises:
looking up an associated subcategory code of the categorized ad;
determining that the associated subcategory code and the user do not have a positive match; and
displaying the categorized ad and its integrated link asking the user if the user would like to show more ads from a same subcategory as the categorized ad.

13. The method of claim 1, wherein the method further comprises:
looking up an associated subcategory code of the categorized ad;
determining that the associated subcategory code and the user have a positive match; and
displaying the categorized ad and its integrated link asking the user whether the user would like to show fewer ads from a same subcategory as the categorized ad.

14. The method of claim 1, wherein the integrated link includes at least one of two options including:
a first option of asking whether to show more ads from a same subcategory as the categorized ad, and
a second option of asking whether to show fewer ads from a same subcategory as the categorized ad.

15. The method of claim 14, further comprising:
receiving user feedback from the integrated link indicating selection of the first option; and
displaying a new integrated link that displays the second option.

16. The method of claim 14, further comprising:
receiving user feedback from the integrated link indicating selection of the second option; and
displaying a new integrated link that displays the first option.

17. An apparatus for online ad delivery, the apparatus comprising:
a creating device configured to create a categorized ad;
a serving device configured to serve the categorized ad and its integrated link to a user;
a receiver device configured to receive user feedback from the categorized ad to formulate a user feedback state of the ad for the user; and
a combining device configured to combine the user feedback state with existing ad serving criteria.

18. The apparatus of claim 17, wherein the creating device is further configured to:
create a taxonomy for generic products and services, wherein the taxonomy includes lowest level categories for products and services;
create a unique code for each lowest level product category and for each lowest level service category;
create an association between at least one unique code and each categorized ad; and
create a new list of ad subcategory codes for at least one user.

19. The apparatus of claim 18, wherein the combining device is further configured to look up an associated subcategory code of the categorized ad.

20. A computer readable medium carrying one or more instructions for online ad delivery, wherein the one or more instructions, when executed by one or more processors, cause the one or more processors to perform the steps of:
creating a categorized ad;
serving the categorized ad and its integrated link to a user;
receiving user feedback from the categorized ad to formulate a user feedback state of the ad for the user; and
combining the user feedback state with existing ad serving criteria.
